(19) United States
(12) Patent Application Publication
(10) Pub. No.: US 2010/0207736 A1
(43) Pub. Date: Aug. 19, 2010

(54) MOBILE RFID READER AND RFID COMMUNICATION METHOD USING SHARED SYSTEM CLOCK

(75) Inventors: Chan-Won Park, Daejeon-city (KR); Nak-Seon Seong, Daejeon-city (KR); Josef Preishuber-Pfluegl, Klagenfurt (AT); David Tschische, Klagenfurt (AT); Gil-Young Choi, Daejeon-city (KR); Cheol-Sig Pyo, Daejeon-city (KR); Jong-Suk Chae, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/682,313

(22) PCT Filed: Oct. 13, 2008
(86) PCT No.: PCT/KR2008/006011

§ 371 Date: Apr. 9, 2010

(30) Foreign Application Priority Data
Oct. 12, 2007 (KR) 10-2007-0103150
Aug. 8, 2008 (KR) 10-2008-0078120

(51) Int. Cl. G06K 17/00

(52) U.S. Cl. 340/10.2

(57) ABSTRACT

The present invention relates to a mobile radio frequency identification (RFID) reader and a RFID communication method using a shared system clock. According to the present invention, clock for synchronizing the mobile RFID readers can be shared without changing hardware of a conventional RHD device. Also, since the shared clock is used, a technology for preventing a collision with the readers can be easily realized in a mobile multi-reader environment.

### TECHNICAL FIELD

The present invention relates to a mobile radio frequency identification (RFID) reader, a RFID communication system, and a RFID communication method using a shared system clock, and more particularly, to a mobile RFID reader and a RFID communication method capable of providing accurate timing information so as to be used in a technology for preventing a collision with each different readers.

The present invention is supported by the Information Technology (IT) Research & Development (R&D) program of the Ministry of Information and Communication (MIC) and the Institute for Information Technology Advancement (IITA) [2006-S-023-02, Development of advanced RFID system technology].

This application claims the benefit of Korean Patent Application Nos. 10-2007-0103150, filed on Oct. 12, 2007, 10-2008-0078120, filed on Aug. 8, 2008, in the Korean Intellectual Property Office, the disclosure of which is incorporated herein in its entirety by reference.

### BACKGROUND ART

In a multi-reader environment where a plurality of readers is used in a set area, interference or collision with each reader has been pointed out as a serious problem and thereby, a method of identifying a channel state before a reader sends a command to a tag (listen before Talk (LBT)) or a method of randomly selecting a channel from among limited channels has been used.

Meanwhile, a technology of communicating numbers of nodes without being collided with each other by using a centralized system clock in a general wired network is widely known. However, in mobile radio frequency identification (RFID) reader technology, the RFID readers do not have a means of sharing timing information and thus, cannot synchronize with a centralized system clock.

In addition, even though any RFID readers exist in a same management area and distributed devices are connected to each other in a wire or by a central adjusting device, when other mobile RFID reader or a fixed-type RFID reader exists around the RFID readers above and is included in other management area, a collision with the readers, that is, a collision with the readers included in each different management areas, cannot be prevented.

Accordingly, various algorithms have been developing for solving a collision with the RFID readers and for example, passive reader synchronization (PRS) and listen window synchronization (LWS) have introduced. In such technologies, since a shared system clock between the RFID readers does not exist, metadata must be sent regularly so as to inform other nodes or peers information about channel occupied state, in order to select the sending time, or a signal of a medium must be sensed to determine sending starting time. However, in such technologies, a waste of frequency channels or a physical change of hardware of the RFID readers is caused.

### DISCLOSURE OF INVENTION

### Technical Problem

It is expected that radio frequency identification (RFID) readers are included in a mobile telephone in the future and thus, the present invention provides accurate timing information to be used in a technology for preventing a collision with each different readers.

### Technical Solution

The present invention provides a mobile RFID reader and a RFID communication method capable of providing accurate timing information so as to be used in a technology for preventing a collision with each different reader using a global system for mobile communications (GSM) based shared system clock.

### Advantageous Effects

According to the present invention, clock for synchronizing the mobile RFID readers can be shared without changing hardware of the conventional RFID device. Also, uplink communication for synchronizing the clock is not required.

Moreover, since the shared clock is used, a technology for preventing a collision with the readers can be easily realized in a mobile multi-reader environment.

### DESCRIPTION OF DRAWINGS

The above and other features and advantages of the present invention will become more apparent by describing in detail exemplary embodiments thereof with reference to the attached drawings in which:

FIG. 1 schematically illustrates a mobile radio frequency identification (RFID) communication system according to an embodiment of the present invention;

FIG. 2 illustrates a cell structure in a global system for mobile communication (GSM) according to an embodiment of the present invention;

FIG. 3 illustrates frame layers in the GSM according to an embodiment of the present invention;

FIG. 4 illustrates five burst formats defined in the GSM according to an embodiment of the present invention;

FIG. 5 illustrates synchronization of a system clock according to an embodiment of the present invention;

FIG. 6 is a block diagram of a RFID reader included in a mobile station according to an embodiment of the present invention; and

FIG. 7 is a flowchart illustrating a RFID communication method of a mobile RFID reader according to an embodiment of the present invention.

### BEST MODE

According to an aspect of the present invention, there is provided a mobile radio frequency identification (RFID) reader including: a mobile communication unit generating a clock synchronization signal at a specific pattern of a downlink frame that is broadcasted from a base transceiver station; and a RFID reader unit sharing a system clock with other mobile RFID readers after the system clock is synchronized by the clock synchronization signal.

The mobile RFID reader may further include an interface unit transmitting the clock synchronization signal to the RFID reader unit from the mobile communication unit.

The specific pattern of the frame may include information indicating starting of the downlink frame or starting of specific burst forming the frame. The burst may include a normal burst, a synchronization burst, an access burst, a frequency correction bursts, and a dummy bursts.

The RFID reader unit may generate a time slot for RFID communication with a tag based on the clock synchronization signal after sharing the system clock with other mobile RFID readers.

The base transceiver station may manage a cell to which a portion of frequency spectrum covered by an entire network is allocated.

The mobile communication unit may communicate with the base transceiver station using one of communication methods comprising Global System for Mobile communication (GSM), Universal Mobile Telecommunications System (UMTS), Code Division Multiple Access (CDMA), and Wideband-CDMA (W-CDMA).

According to another embodiment of the present invention, there is provided a mobile radio frequency identification (RFID) communication method of a mobile RFID reader, the method including: generating a clock synchronization signal at a specific pattern of a downlink frame that is broadcasted from a base transceiver station; and sharing a system clock with other mobile RFID readers after the system clock is synchronized by the clock synchronization signal.

According to another embodiment of the present invention, there is provided a mobile radio frequency identification (RFID) communication system including: a base transceiver station broadcasting a downlink frame according to network protocol; and a mobile RFID reader sharing a system clock with other mobile RFID readers after the system clock is synchronized by a clock synchronization signal generated at a specific pattern of the downlink frame.

### Mode for Invention

The present invention will now be described more fully with reference to the accompanying drawings, in which exemplary embodiments of the invention are shown. In the drawings, like reference numerals denote like elements, and the sizes and thicknesses of layers and regions are exaggerated for clarity. In the description of the present invention, if it is determined that a detailed description of commonly-used technologies or structures related to the invention may unnecessarily obscure the subject matter of the invention, the detailed description will be omitted. In addition, it will also be understood that when some part ‘includes’ some elements, other elements can be further included, instead of excluding them, as far as, there is no particular opposite description. The terms illustrated in the specification ‘. . . unit’ or ‘. . . device’ are denoted as a unit for processing at least one function or operation and may be embodied by hardware, software, or a combination thereof.

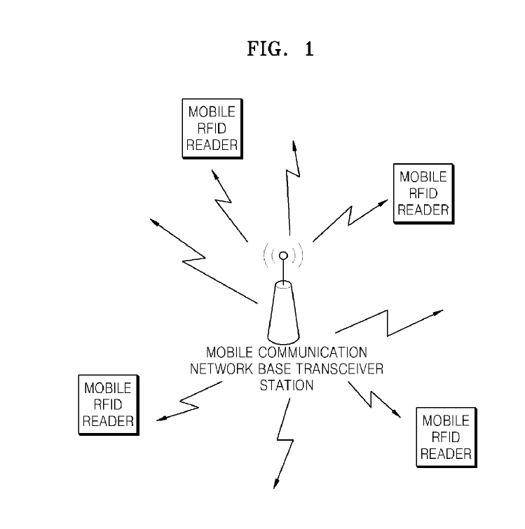

FIG. 1 schematically illustrates a mobile radio frequency identification (RFID) communication system according to an embodiment of the present invention.

Referring to FIG. 1, the mobile RFID system according to the current embodiment includes a Mobile communication network base transceiver station (hereinafter, a base transceiver station) and various mobile RFID readers for communicating with the base transceiver station. The mobile RFID readers may be RFID readers embedded in a mobile station.

The region covered by the base transceiver station may be cells to which specific frequency spectrum of an entire network is allocated. In this case, the base transceiver station which manages a cell and the mobile RFID readers in the cell are communicated with each other.

In the present invention, timing information shared by all mobile RFID readers included in the region covered by the base transceiver station is provided from the base transceiver station using protocol of an existing network, in order to improve a RFID communication of the mobile RFID readers and to prevent a collision with the RFID readers. The timing information is based on a frame concept and is transmitted to a RFID logic from a mobile communication logic of the mobile RFID reader.

The base transceiver station broadcasts downlink burst frames according to protocols of a network standard. The mobile reader detects a specific pattern that is previously agreed in the received burst frame and synchronizes a system clock with the base transceiver station based on the detected pattern, thereby sharing the system clock with other mobile RFID reader.

The present invention can be applied to an arbitrary base transceiver station based network standard using the frame concept, that is, Global System for Mobile communication (GSM), Universal Mobile Telecommunications System (UMTS), Code Division Multiple Access (CDMA), and Wideband-CDMA (W-CDMA). Hereinafter, for convenience of description, a GSM network standard is described as an example.

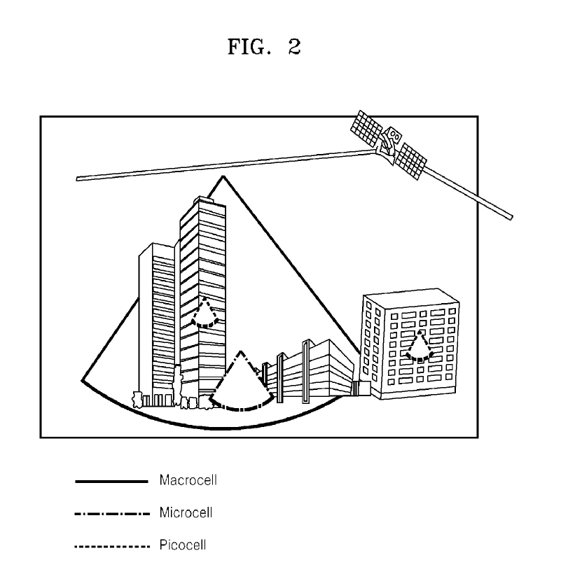

FIG. 2 illustrates a cell structure in the GSM according to an embodiment of the present invention.

In the GSM, a cell structure is used to divide usable frequency ranges and only a portion of frequency spectrum is respectively allocated to all base transceiver stations (BTS). The range of the BTS is limited to a fixed region. Accordingly, the frequency can be re-used by such properties in the GSM.

Referring to FIG. 2, cells (Macrocell, Microcell, and Picocell) having each different size are combined to accomplish the maximum network coverage so as to provide appropriate bandwidth according to traffic density expected in the fixed region.

A technology for realizing the system clock shared by the RFID readers using the GSM is closely related to the cell concept. In general, timing of the frames transmitted between each different BTS is not synchronized with each other in the GSM. In other words, the clock realized by the specific BTS may be shared only with the RFID readers located in the cell to which the specific BTS manages. However, in consideration of a substantial size of the cells ranging from few hundreds m to about 20 Km, it is satisfactory that the clock is shared with the readers in the same cell.

The GSM is based on a combination of Time Division Media Access (TDMA) and Frequency Division Multiplexing (FDM). Logic channels such as a control channel and a traffic channel are multiplexed on a less number of physical channels according to the frame concept which will be described later.

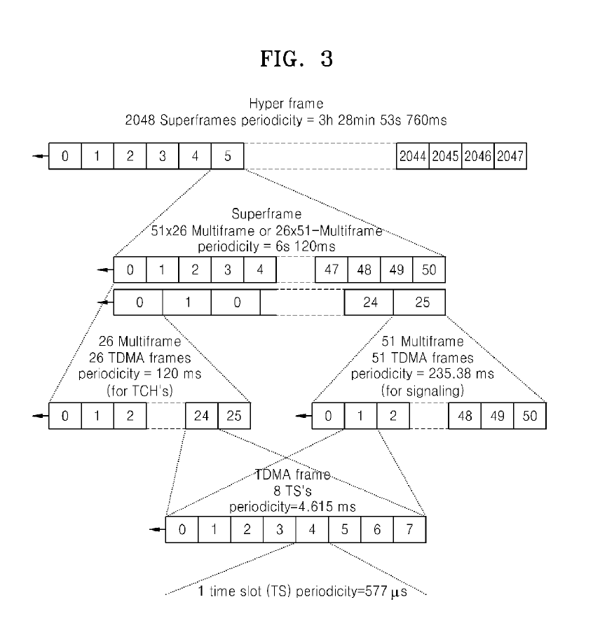

FIG. 3 illustrates frame layers in the GSM according to an embodiment of the present invention.

The minimum unit of transmission on a specific frequency is denoted as a burst and all bursts correspond to a time slot (TS). Numbers ranging from 0 to 7 are designated to the bursts in the order of an ascending series and eight bursts or sequences of TS form TDMA frames.

In the cell of the GSM, proper frame numbers are designated to each TDMA frame. The proper frame numbers are repeated in an accurate time period of 3 hours 28 minutes 53 seconds and 760 milli-seconds and this is denoted as hyperframe. Multiframe and superframe are interposed between a basic TDMA frame and the hyperframe.

In order to communicate with the base transceiver station, the mobile station checks a synchronization channel (SCH) and a frequency correction channel (FCC) which are dedicated as downlink control channels representing chronology of other remaining control channels. Moreover, various methods of multiplexing various logic channels on the physical channels exist and some rules must be obeyed. In particular, in the GSM 05.02, the FCC and SCH bursts must be included in a first TS, TS0, of a Broadcast Control Channel (BCCH) carrier at a specific frame number, and transmitted. Thus, these bursts may be interpreted as a regular clock tick by a RFID sub-system.

The logic channels and physical channels used in the GSM are described above. However, the present invention can be also applied to other logic channels and physical channels used in other mobile communication standard.

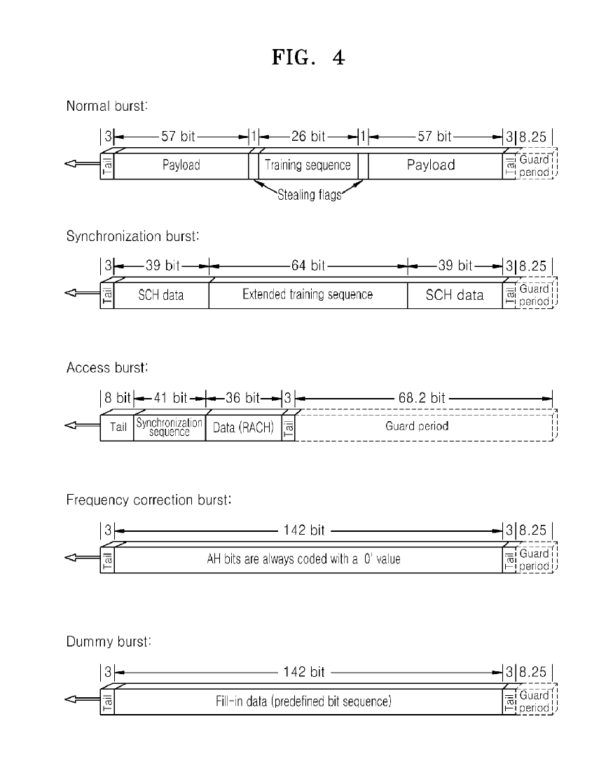

FIG. 4 illustrates five burst formats defined in the GSM according to an embodiment of the present invention.

Referring to FIG. 4, a normal burst, a synchronization burst, an access burst, a frequency correction bursts, and a dummy bursts are defined in the GSM. Each burst has different structure. However, these bursts are the same in that duration of all bursts is accurately 577 μs and 156.25 bits can be transmitted during such duration.

The clock shared by the mobile RFID readers included in a cell of the GSM is formed by detecting a specific GSM pattern during GSM downlink communication by a GSM logic (for example, starting of the TDMA frame, starting of the synchronization burst, or a starting point of specific burst transmission) and a mobile RFID logic is triggered directly or after a predetermined delay time by the shared clock so as to start to command to a tag.

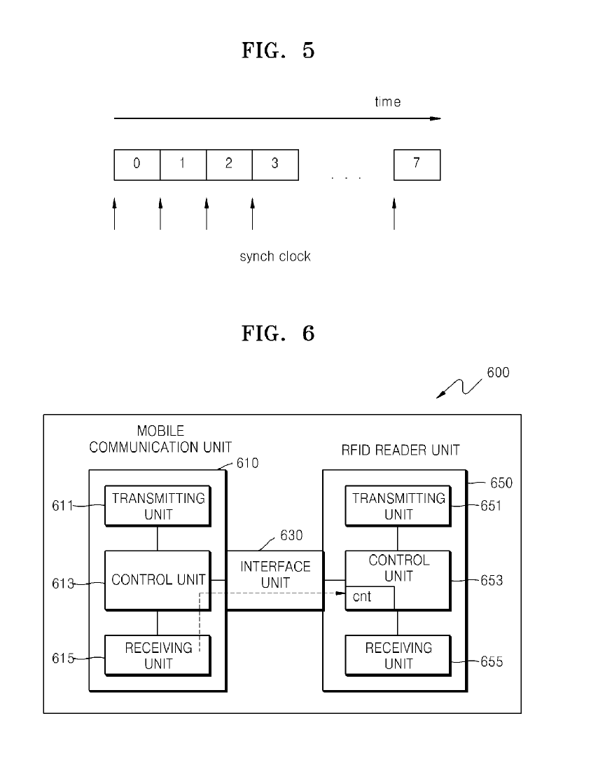

FIG. 5 illustrates synchronization of a system clock according to an embodiment of the present invention.

Referring to FIG. 5, in transmitting the TDMA frames formed of eight bursts in the GSM, a clock signal is generated in the starting point of reception of each burst so that the RFID system clock is synchronized and the system clock of all mobile RFID readers in the cell of the GSM is shared.

When the clock of all mobile RFID readers in the cell of the GSM is shared, an interval between two or more subsequent clock ticks may be used as a means for measuring an expected occupying time of the RFID channels or a talk time.

In addition, the synchronized system clock (synchronization clock) may be used as a synchronization signal for RFID transmitting and as the TS for RFID communication with the tag, or a signal for the TS.

In the present invention, the GSM is used as an example and any base station based network standard using the fame concept that is similar to the GSM can be used to realize the shared clock approach.

FIG. 6 is a block diagram of the RFID reader (mobile RFID reader) embedded in the mobile station according to an embodiment of the present invention.

Referring to FIG. 6, the mobile RFID reader 600 according to the present invention includes a mobile communication unit 610, an interface unit 630, and a RFID reader unit 650.

The mobile communication unit 610 includes a transmitting unit 611, a control unit 613, and a receiving unit 615.

The transmitting unit 611 and the receiving unit 615 communicate with the mobile communication base transceiver station using protocol of one of the mobile communication methods such as GSM, UMTS, CDMA, and W-CDMA. The receiving unit 615 receives a downlink frame broadcasted by the base transceiver station of the network which covers the specific frequency spectrum and generates a clock synchronization signal in the specific pattern of the frame received according to the control signal of the control unit 613.

The specific pattern of the frame may be a starting point of the frame or the starting point of the burst. The burst may be the synchronization burst and may be received by downlink from the base transceiver station. The mobile communication unit 610 may transmit the clock synchronization signal formed by using the starting point of the frame, the result of the detection for the starting point of the burst, or the result of the detection directly or after a predetermined delay time to the RFID reader unit 650.

The interface unit 630 transmits the clock synchronization signal that the mobile communication unit 610 generates by using the starting point of the frame, the result of the detection for the starting point of the burst, or the result of the detection to the RFID reader unit 650.

The RFID reader unit 650 includes transmitting unit 651, a control unit 653, and a receiving unit 655.

The RFID reader unit 650 uses the timing information for determining an interval for performing tasks, the tasks being required for regular scheduling in order to solve access of or a collision with media, for example, sensing carrier. Various kinds of the frame patterns received by the mobile communication unit 610 may be used as the clock tick.

The transmitting unit 651 and the receiving unit 655 perform RFID communication with the tag.

The control unit 653 synchronizes the RFID reader unit 650 by the clock synchronization signal transmitted from the mobile communication unit 610. When the RFID reader unit 650 is synchronized and thus, the system clock is shared with other mobile RFID readers in the network or the cell, the control unit 653 counts the clock ticks by a counter and the interval between two or more subsequent clock ticks may be used to generate the TS for RFID communication with the tag or may be used as a means for measuring an expected occupying time of the RFID channels or remaining talk time.

The RFID reader unit 650 may perform secondary RFID operation by the shared system clock, the secondary RFID operation including internal and external events logging such as whether a sensor threshold value exceeds, a RFID related functioning trigger such as a smart sensor, or an actuator, and a RFID inventory trigger, in addition to synchronization.

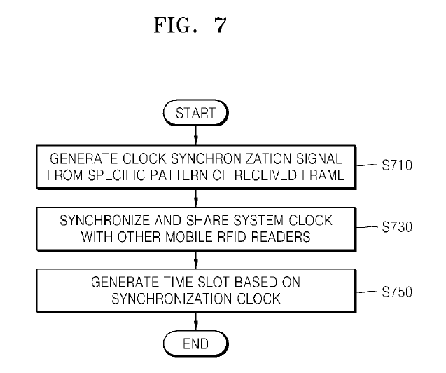

FIG. 7 is a flowchart illustrating a RFID communication method of the mobile RFID reader according to an embodiment of the present invention. Hereinafter, the detailed description that is already mentioned above is omitted.

In operation 710, the mobile station generates the clock synchronization signal at the specific pattern of the downlink frame that is broadcasted by the base transceiver station of the network which covers the specific frequency spectrum. The specific pattern may include information indicating starting of the downlink frame or starting of the burst forming the frame.

In operation 730, the mobile station is synchronized by the clock synchronization signal and shares the system clock with other mobile RFID readers.

The mobile station shares the system clock with other mobile RFID readers by the clock synchronization and then, generates the TS for RFID communication with the tag based on the synchronization clock, in operation 750. The mobile station may determine the starting and ending of the TS by one or more clock ticks. Thus, when communication with the tag is required, the number of the TS allocated by the base transceiver station and channel location information are used to perform RFID communication with the tag without a collision with other mobile station.

In the present invention, the specific logic channel is detected from the physical channel to which various logic channels are multiplexed and the result of the detection is shared with all mobile RFID readers in the network or the cell so that the synchronized system clock (that is, synchronization clock) is shared and the synchronization clock is used as clock tick information, thereby reducing a collision with the RFID readers during the RFID communication.

In alternative embodiments, hard-wired circuitry may be used in place of or in combination with processor/controller programmed with computer software instructions to implement the invention. Thus, embodiments of the invention are not limited to any specific combination of hardware circuitry and software.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A mobile radio frequency identification (RFID) reader comprising:
a mobile communication unit generating a clock synchronization signal at a specific pattern of a downlink frame that is broadcasted from a base transceiver station; and
a RFID reader unit sharing a system clock with other mobile RFID readers after the system clock is synchronized by the clock synchronization signal.

2. The mobile RFID reader of claim 1, further comprising an interface unit transmitting the clock synchronization signal to the RFID reader unit from the mobile communication unit.

3. The mobile RFID reader of claim 1, wherein the specific pattern of the frame comprises information indicating starting of the downlink frame or starting of specific burst forming the frame.

4. The mobile RFID reader of claim 3, wherein the burst comprises a normal burst, a synchronization burst, an access burst, a frequency correction bursts, and a dummy bursts.

5. The mobile RFID reader of claim 1, wherein the RFID reader unit generates a time slot for RFID communication with a tag based on the clock synchronization signal after sharing the system clock with other mobile RFID readers.

6. The mobile RFID reader of claim 1, wherein the base transceiver station manages a cell to which a portion of frequency spectrum veered by an entire network is allocated.

7. The mobile RFID reader of claim 1, wherein the mobile communication unit communicates with the base transceiver station using one of communication methods comprising Global System for Mobile communication (GSM), Universal Mobile Telecommunications System (UMTS), Code Division Multiple Access (CDMA), and Wideband-CDMA (W-CDMA).

8. A mobile radio frequency identification (RFID) communication method of a mobile RFID reader, the method comprising:
generating a clock synchronization signal at a specific pattern of a downlink frame that is broadcasted from a base transceiver station; and
sharing a system clock with other mobile RFID readers after the system clock is synchronized by the clock synchronization signal.

9. The method of claim 8, wherein the specific pattern of the frame comprises information indicating starting of the downlink frame or starting of specific burst forming the frame.

10. The method of claim 9, wherein the burst comprises a normal burst, a synchronization burst, an access burst, a frequency correction bursts, and a dummy bursts.

11. The method of claim 8, further comprising generating a time slot for RFID communication with a tag based on the clock synchronization signal after sharing the system clock with other mobile RFID readers.

12. The method of claim 8, wherein the base transceiver station manages a cell to which a portion of frequency spectrum covered by an entire network is allocated.

13. The method of claim 8, wherein the mobile RFID reader communicates with the base transceiver station using one of communication methods comprising Global System for Mobile communication (GSM), Universal Mobile Telecommunications System (UMTS), Code Division Multiple Access (CDMA), and Wideband-CDMA (W-CDMA).

14. A mobile radio frequency identification (RFID) communication system comprising:
a base transceiver station broadcasting a downlink frame according to network protocol; and
a mobile RFID reader sharing a system clock with other mobile RFID readers after the system clock is synchronized by a clock synchronization signal generated at a specific pattern of the downlink frame.

15. The system of claim 14, wherein the mobile RFID reader communicates with the base transceiver station using one of communication methods comprising Global System for Mobile communication (GSM), Universal Mobile Telecommunications System (UMTS), Code Division Multiple Access (CDMA), and Wideband-CDMA (W-CDMA).
